(19) United States
(12) Patent Application Publication
(10) Pub. No.: US 2008/0138608 A1
(43) Pub. Date: Jun. 12, 2008

(54) Furniture Finish Laminate Flooring

(76) Inventors: Yiming Ma, Leshan City (CN); Zhongqing Xia, Leshan City (CN); Hua Yang, Leshan City (CN); Heng Zhang, Leshan City (CN)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/739,984

(22) Filed: Apr. 25, 2007

(30) Foreign Application Priority Data
Dec. 11, 2006 (CN) 200620036595.7

(51) Int. Cl. B32B 27/42

(52) U.S. Cl. 428/332; 428/524

(57) ABSTRACT

A furniture finish laminate flooring comprises the base material layer, balance layer and decorating layer that is coated with alumina-contained melamine formaldehyde resin. The furniture finish laminate flooring has not only the same advantages of not-apt-to-deform and high abrasive resistance as the traditional consolidated compound flooring but also the high brightness and definition like the surfaces of high grade furniture. The present invention is characterized in reasonable design, simple structure, easy production, saving of raw materials and reduction of production cost, whereby it can well meet the demands for high definition quality of flooring covering by the high-end customers, with an excellent prospect for generalization and application.

### FIELD OF THE INVENTION

The present invention relates generally to flooring which is used in the field of building materials and architecture decoration technology. More precisely, it relates to a furniture finish laminate flooring which can be especially adapted to apartments and residential houses.

### BACKGROUND OF THE INVENTION

With the rapid development of national economy in China, the progress of urbanization has been speeded up vigorously. The constant improvement of living standards of the Chinese people has enabled them to expect that their living and working conditions will be further improved. Therefore, special attention has been paid to the decoration and interior designing of residential houses. As it is well known, solid wood flooring has many advantages, such as nice-looking, luxurious, genuine timber grain and comfortable dwelling, and so it is deeply favored at the very start when it appears at market. But, it has to be noted that solid wood flooring is apt to deform and be poor in abrasion or wear resistance. Subsequently, another new type of flooring has turned up, i.e., consolidated compound flooring covering. The so-called consolidated compound flooring is a kind of flooring wherein the surfaces of the artificial board base materials including particle boards, MDF boards or HDF boards are covered with a layer or multi layers of special purpose papers dipped into thermosetting amino resin, with the balance layer added to the back sides of such base materials and the abrasion or wear resistant layer to the front sides, through thermal compression. In comparison to solid wood flooring, the consolidated compound floorings feature high abrasion or wear resistance, being not likely to deform, and therefore such compound floorings are much favored in the market. The traditional consolidated compound flooring is of composite structure consisting of the abrasion or wear resistant paper layer, decorating layer, base material layer, and balance layer. However, as the traditional consolidated compound flooring has, on its surface, a layer of abrasion resistant paper that covers the decorating layer, the designs and patterns of the decorating layer become visually vague or dim, with poor definition, resulting in failure to meet the demands of a higher level of customers.

### SUMMARY OF THE INVENTION

The present invention provides a furniture finish laminate flooring featuring novel design and simple structure as compared to the prior art. Like the consolidated compound flooring, the composite flooring of the present invention is not likely to deform, with the advantage of high abrasion resistance or wear, and, additionally, it features the same high brightness and definition as surfaces of high-grade furniture.

The present invention is prepared through the following technical approaches. The back side of the base material is laminated with a balance layer, which may be one or more layers, wherein the front side of the base material layer is laminated with a decorating layer that is coated with alumina-contained melamine formaldehyde resin. In another embodiment the decorating layer may be coated with or cemented by permeating, wear resistant materials, such as decorating paper or decorating cloth, or the like, which is used as the decorating layer. Structurally, the top of the base material is of a mono-layer structure, as the decorating layer, which is coated with, or cemented by permeating, a wear resistant material, such as alumina-contained melamine formaldehyde resin, instead of the existing double-layer structure comprising abrasion or wear resistant paper layer and decorating layer as used in the traditional consolidated compound flooring; thus the furniture finish laminate flooring of the present invention is of at least three-layer composite structure. Subsequently, the furniture finish laminate flooring has better abrasion or wear resistance in operating performance, and the abrasion or wear resistance data has met the requirements of China's National Standard GB/T 18102. Concurrently it has the characteristics of high definition like the surfaces of high grade furniture.

As the furniture finish laminate flooring of the present invention is of simple structure, having only three or so layers, it has the more remarkable advantages such as simplified production processes, saving of raw materials and reduction of production cost than the traditional consolidated compound flooring. Furthermore, a silencing mat or pad can also be attached to the undersurface of the balance layer to improve sound insulation effects markedly and further raise the quality grades of products.

### BRIEF DESCRIPTION OF THE DRAWINGS

FIG. 1 is a structural schematic view according to the present utility model;

FIG. 2 is a schematic A-A view of FIG. 1 (in rotation)

FIG. 3 is a structural schematic view with additional silencing mat layer or pad.

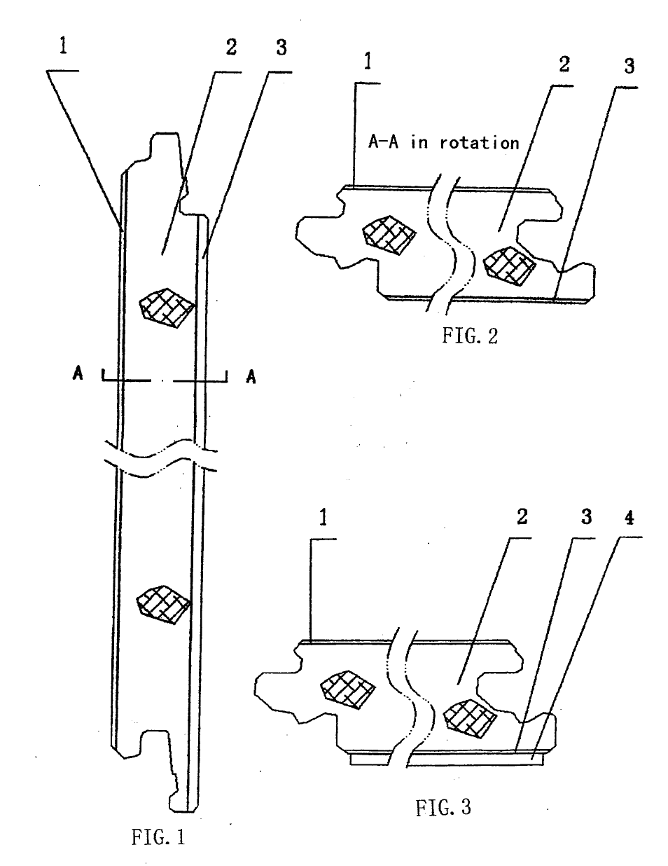

### DESCRIPTION OF THE PREFERRED EMBODIMENTS

The invention can perhaps be better understood from the drawings. The furniture finish laminate flooring according to the present utility model is achieved in such a way as follows. MDF board is used as the base material 2, the back side of which is covered with a balance layer 3 and the front side of which is covered with a decorating layer 1 that is coated with alumina-contained melamine formaldehyde resin. Additionally, a sound insulation mat or pad 4 can be attached to the undersurface of the balance layer 3 so that a good sound proof furniture finish laminate flooring is formed for house installation.

HDF board can also be used as the base material 2, the back side of which is covered with a balance layer 3 and the front side of which is covered with a decorating layer 1 that is coated with alumina-contained melamine formaldehyde resin.

In another embodiment of the invention, MDF/HDF board, particle board, multilayer (two layers or more) plywood, solid wood board, and bamboo wood board, etc., is used as the base material layer 2, the back side of which is laminated with a balance layer 3 (one layer or more layers) and the front side of which is laminated with a decorating layer 1 that is coated with, or cemented by permeating, wear resistant material. Between said decorating layer (1) and said base material layer (2) may, or may not, be added a connection layer. Additionally, a sound insulation mator pad 4 can be attached to the bottom face of the balance layer 3, whereby a good sound proof furniture finish laminate flooring is formed for house installation.

1. A furniture finish laminate flooring, comprising a base material layer (2) back of which is laminated with balance layer (3), wherein the front side of base material layer (2) is laminated with a decorating layer (1) being coated with alumina-containing melamine formaldehyde resin.

2. The furniture finish laminate flooring as claimed in claim 1, wherein the undersurface of said balance layer (3) is further laminated with a silencing mat (4).

3. A laminate flooring, which comprises
a base layer having a first surface and a second surface,
a decorating layer laminated to the first surfaces of the base layer, and
a balance layer attached to the second surface of the first base layer,
wherein the decorating layer is coated with alumina-containing melamine formaldehyde resin.

4. A flooring comprising a balance layer (3), base material layer (2), and decorating layer (1), wherein the base material layer (2) is, but not limited to, MDF/HDF board, particle board, multilayer (two layers or more) plywood, solid wood board and bamboo wood board, etc., of 2 mm or more in thickness, wherein between said decorating layer (1) and said base material layer (2) a connection layer may optionally be added, wherein the balance layer (3) may be one or more layers, and wherein the decorating layer (1) is the decorating material, the surface of which is coated with, or cemented by permeating, the wear resistant materials, such as, but not limited to, the decorating paper, decorating cloth, or the like.

5. The flooring as claimed in claim 4, wherein the undersurface of said balance layer (3) can further be added with mat layer or pad (4).
